(19) United States
(12) Patent Application Publication
(10) Pub. No.: US 2026/0166882 A1
(43) Pub. Date: Jun. 18, 2026

(54) PRINTING METHOD AND PRINTING APPARATUS

(71) Applicant: SEIKO EPSON CORPORATION, Tokyo (JP)

(72) Inventor: Masato SUZUKI, SHIOJIRI-SHI (JP)

(21) Appl. No.: 19/421,857

(22) Filed: Dec. 16, 2025

(30) Foreign Application Priority Data
Dec. 16, 2024 (JP) 2024-219629

(51) Int. Cl. B41J 2/165; B41J 11/00; B41J 25/00

(52) U.S. Cl. CPC B41J 2/16526; B41J 11/008; B41J 25/005; B41J 2002/16573

(57) ABSTRACT

In a printing method according to an aspect of the present disclosure, first ejection that is ejection of liquid for forming an image on a medium, and second ejection that is ejection of the liquid for flushing in a predetermined region outside an end of the medium in a primary scanning direction are performed during one-pass operation of moving a carriage once in a predetermined direction, and the second ejection through a flushing target nozzle row is performed at a timing when an affected nozzle row is located outside the medium and at least a portion of the carriage is present at a position where the portion overlaps with the medium when viewed in a direction in which the liquid is ejected.

The present application is based on, and claims priority from JP Application Serial Number 2024-219629, filed Dec. 16, 2024, the disclosure of which is hereby incorporated by reference herein in its entirety.

### BACKGROUND

### 1. Technical Field

The present disclosure relates to a printing method and a printing apparatus.

### 2. Related Art

Flushing in which liquid is ejected and discarded via a nozzle is known as maintenance performed to prevent or eliminate failure in ejection of the liquid via the nozzle. In relation to the flushing described above, JP-A-2012-240237 discloses a technology for efficiently performing the flushing during image formation by adding flushing data to print data, the flushing data used to eject ink in an ink receiving region provided at a position corresponding to an end of a sheet.

JP-A-2012-240237 is an example of the related art.

Crosstalk is known as a phenomenon in which deformation of a flow path such as a liquid chamber that communicates with a nozzle, which occurs when liquid is ejected via the nozzle, affects ejection of the liquid via another nozzle close to the deformed nozzle. The technology described in JP-A-2012-240237 allows the flushing to be performed efficiently during image formation, but there is a concern that the crosstalk that occurs during the period for which the flushing is performed affects the quality of the image formed on a medium.

### SUMMARY

A printing method according to an aspect of the present disclosure is a printing method performed by a printing apparatus including a print head having multiple nozzle rows, a carriage in which the print head is incorporated, and a controller configured to control ejection of liquid via the nozzle rows and movement of the carriage in a primary scanning direction, the printing method including performing, during a one-pass operation of moving the carriage, first ejection that is ejection of the liquid for forming an image on a medium, and second ejection that is ejection of the liquid for flushing in a predetermined region outside an end of the medium in the primary scanning direction, wherein the second ejection through a flushing target nozzle row that is the nozzle row on which the second ejection is performed is performed at a timing when an affected nozzle row is located outside the medium and at least a portion of the carriage is present at a position where the portion overlaps with the medium when viewed in a direction in which the liquid is ejected, the one-pass operation is an operation of moving the carriage once toward one side in the primary scanning direction, and the affected nozzle row is the nozzle row affected by the ejection of the liquid due to the second ejection performed through the flushing target nozzle row.

A printing apparatus according to another aspect of the present disclosure includes: a print head having multiple nozzle rows; a carriage in which the print head is incorporated; and a controller configured to control ejection of liquid via the nozzle rows and movement of the carriage in a primary scanning direction, wherein the controller is configured to perform, during a one-pass operation of moving the carriage, first ejection that is ejection of the liquid for forming an image on a medium, and second ejection that is ejection of the liquid for flushing in a predetermined region outside an end of the medium in the primary scanning direction, the second ejection through a flushing target nozzle row that is the nozzle row on which the second ejection is performed is performed at a timing when an affected nozzle row is located outside the medium and at least a portion of the carriage is present at a position where the portion overlaps with the medium when viewed in a direction in which the liquid is ejected, the one-pass operation is an operation of moving the carriage once toward one side in the primary scanning direction, and the affected nozzle row is the nozzle row affected by the ejection of the liquid due to the second ejection performed through the flushing target nozzle row.

### BRIEF DESCRIPTION OF THE DRAWINGS

FIG. 1 is a diagrammatic view showing an overview of the configuration of a printing apparatus according to an embodiment.

FIG. 2 is a diagrammatic view of a print head according to the embodiment.

FIG. 3 is a diagrammatic view showing an example of each nozzle row and the range over which a flow path for the nozzle row is present.

FIG. 4 is a diagrammatic view showing an example of the configuration of a platen according to the embodiment.

FIG. 5 is a diagrammatic view showing liquid ejection data used to perform image formation and flushing in one pass.

FIG. 6 is a diagrammatic view showing flushing according to Comparative Example.

FIG. 7 is a diagrammatic view showing the flushing according to the embodiment.

FIG. 8 is a diagrammatic view showing the flushing according to the embodiment.

FIG. 9 is a flowchart showing an example of the procedure of the operation of the printing apparatus according to the embodiment.

FIG. 10 is a diagrammatic view showing the flushing performed when two nozzle rows present on opposite sides of a flushing target nozzle row are affected nozzle rows.

### DESCRIPTION OF EMBODIMENTS

An embodiment will be described below with reference to the drawings. To clarify the following description, the description and drawings are partially omitted or simplified as appropriate. In the drawings, the same elements have the same reference characters, and no duplicated description of the same elements is made as required.

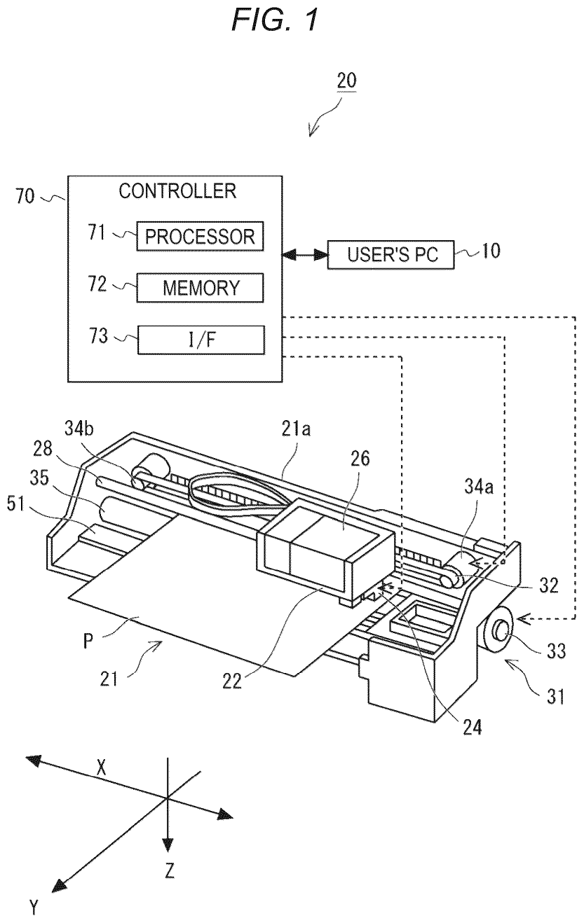

FIG. 1 is a diagrammatic view showing an overview of the configuration of a printing apparatus 20 according to the embodiment. The printing apparatus 20 is an inkjet printer that operates in an inkjet scheme to perform printing with ink.

The printing apparatus 20 according to the present embodiment includes a sheet feeding mechanism 31, a printer mechanism 21, and a controller 70 by way of example, as shown in FIG. 1. The sheet feeding mechanism 31 conveys a medium P in a Y direction in FIG. 1 (that is, what is called a conveyance direction or secondary scanning direction) via a sheet feeding roller 35 driven by a drive motor 33. The medium P is, for example, a sheet, but is not limited thereto, and may be a medium made of any material, such as a resin film. The printer mechanism 21 performs printing by ejecting liquid (ink droplets) from a print head 24 onto the medium P conveyed onto a platen 51 by the sheet feeding mechanism 31. The controller 70 controls the entire printing apparatus 20. In the present embodiment, in particular, the controller 70 controls the ejection of the liquid via nozzle rows of the print head 24 and the movement of a carriage 22, which will be described later, in an X direction in FIG. 1 (that is, what is called primary scanning direction). Note that a Z direction represents the direction in which the liquid is ejected in FIG. 1.

The printer mechanism 21 includes a carriage motor 34a, a driven roller 34b, a carriage belt 32, the carriage 22, an ink cartridge 26, and the print head 24 by way of example. The carriage motor 34a is disposed at one end (right side in FIG. 1) of a mechanical frame 21a, and the driven roller 34b is disposed at the other end (left side in FIG. 1) of the mechanical frame 21a. The carriage belt 32 engages with the carriage motor 34a and the driven roller 34b. The carriage belt 32 causes the carriage 22 to move back and forth in the primary scanning direction along a guide 28 as the carriage motor 34a is driven. The ink cartridge 26 is incorporated in the carriage 22, and separately houses multiple types of color ink, cyan (C), magenta (M), yellow (Y), and black (K) or CMYK, each containing dye or pigment as a colorant solved in water as a solvent. The print head 24 receives the ink supplied from the ink cartridge 26 and ejects the ink droplets. The print head 24 is incorporated in the carriage 22 and moves in the primary scanning direction as the carriage 22 moves.

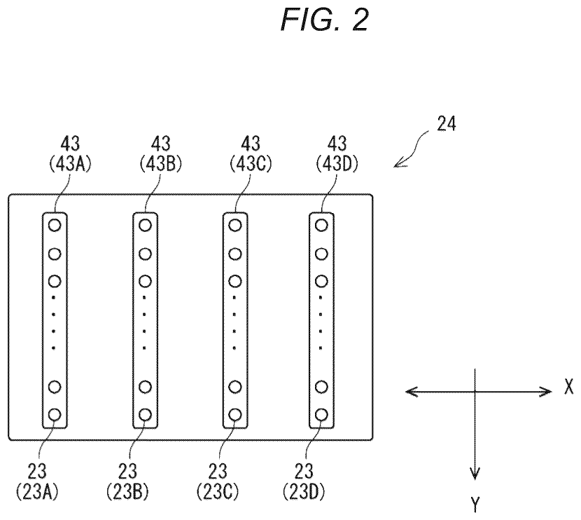

FIG. 2 is a diagrammatic view of the print head 24. In more detail, FIG. 2 is a diagrammatic view of a surface of the print head 24 that is the surface facing the medium P. The print head 24 has multiple nozzle rows, as shown in FIG. 2. In the present embodiment, the print head 24 has four nozzle rows 43A, 43B, 43C, and 43D by way of example. The nozzle row 43A is, for example, a nozzle row configured with a series of nozzles 23A, via which the cyan ink is ejected. The nozzle row 43B is, for example, a nozzle row configured with a series of nozzles 23B, via which the magenta ink is ejected. The nozzle row 43C is, for example, a nozzle row configured with a series of nozzles 23C, via which the yellow ink is ejected. The nozzle row 43D is, for example, a nozzle row configured with a series of nozzles 23D, via which the black ink is ejected.

It is assumed in the present disclosure that the nozzle rows 43A, 43B, 43C, and 43D are referred to as nozzle rows 43 when they are not particularly distinguished from each other. Furthermore, the nozzles 23A, 23B, 23C, and 23D are referred to as nozzles 23 when they are not particularly distinguished from each other.

The series of multiple nozzles 23 that constitute one nozzle row are arranged in a direction perpendicular to the primary scanning direction, that is, the direction in which the medium P is conveyed. In the present embodiment, the print head 24 has four nozzle rows by way of example, but the number of the nozzle rows provided in the print head 24 is not limited to four as long as the print head 24 has multiple nozzle rows. For example, the print head 24 may have six nozzle rows via which different types of color ink (liquid) are ejected. In the print head 24, the multiple nozzle rows only need to be arranged in the primary scanning direction, and the arrangement of the colors of the multiple types of ink ejected via the nozzle rows is not limited to the example described above.

A liquid (ink) flow path such as a liquid chamber is coupled to the nozzles 23 in each of the nozzle rows, and the liquid (ink) is ejected when a piezoelectric device controlled by the controller 70 is so driven that the liquid chamber contracts. That is, when the liquid is ejected via the nozzles 23 in each of the nozzle rows, the flow path coupled to the nozzles is deformed. The deformation may affect the flow path coupled to another nozzle, and may affect the ejection of the liquid (ink) via the other nozzle. That is, a phenomenon called crosstalk may occur. In particular, large-dot droplets are simultaneously ejected via the series of nozzles that constitute each of the nozzle rows in the flushing operation, so that the crosstalk may greatly affect the other nozzle row. In more detail, the flushing performed on a certain nozzle row affects another nozzle row disposed adjacent to the certain nozzle row in terms of crosstalk. Note that the term “large-dot” means a relatively large dot formed, for example, when multiple dots having different sizes can be selectively ejected by controlling a drive pulse that drives the piezoelectric device. In the following description, a nozzle row affected by a certain nozzle row in terms of crosstalk is referred to as an affected nozzle row. In addition, a nozzle row that affects another nozzle row in terms of crosstalk is referred to as an affecting nozzle row. In the present embodiment, one affected nozzle row is present per affecting nozzle row. Specifically, the nozzle row 43A and the nozzle row 43B are related to each other in a way that one affects the other in terms of crosstalk. The nozzle row 43C and the nozzle row 43D are related to each other in a way that one affects the other in terms of crosstalk. That is, the nozzle row 43A and the nozzle row 43B constitute a nozzle row group in which the crosstalk occurs, and the nozzle row 43C and the nozzle row 43D constitute a nozzle row group in which the crosstalk occurs. Therefore, in the present embodiment, the crosstalk does not occur between the nozzle row 43B and the nozzle row 43C. In more detail, in the present embodiment, the crosstalk occurs as follows: The crosstalk from the nozzle row 43A affects only the nozzle row 43B, and the crosstalk from the nozzle row 43B affects only the nozzle row 43A. The crosstalk from the nozzle row 43C affects only the nozzle row 43D, and the crosstalk from the nozzle row 43D affects only the nozzle row 43C. As described above, in the present embodiment, a nozzle row group in which the crosstalk occurs is configured only with a pair of two adjacent nozzle rows.

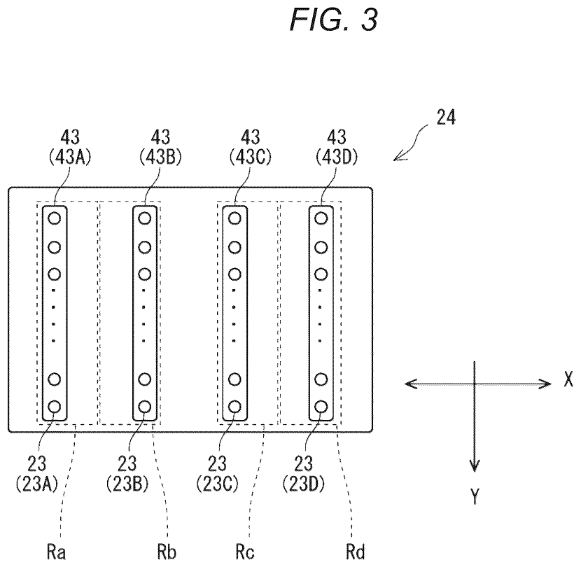

As described above, the reason why a nozzle row group in which the crosstalk occurs is configured only with a pair of two adjacent nozzle rows is, for example, that the flow paths for the nozzles 23 are arranged as shown in FIG. 3 in the print head 24. FIG. 3 is a diagrammatic view showing an example of each of the nozzle rows 43 and the range over which the flow path for the nozzle row is present. In the example shown in FIG. 3, the flow path for the nozzles 23A, which constitute the nozzle row 43A, is present over a range Ra, and the flow path for the nozzles 23B, which constitute the nozzle row 43B, is present over a range Rb. The flow path for the nozzles 23C, which constitute the nozzle row 43C, is present over a range Rc, and the flow path for the nozzles 23D, which constitute the nozzle row 43D, is present over a range Rd. The range Ra and the range Rb are adjacent to each other, and the range Rc and the range Rd are adjacent to each other, but the range Rb and the range Rc are separate from each other, as shown in FIG. 3. As described above, the nozzles 23 are each biased toward one side of the flow path (liquid chamber) instead of disposed at the center thereof. Note, for example, that the flow path for the nozzles 23A and the flow path for the nozzles 23B may be configured to be line symmetric with respect to the conveyance direction as the axis of symmetry. Similarly, the flow path for the nozzles 23C and the flow path for the nozzles 23D may be configured to be line symmetric with respect to the conveyance direction as the axis of symmetry. When the flow paths are arranged as described above or otherwise arranged, the nozzle row groups between which the crosstalk occurs are configured only with a pair of two adjacent nozzle rows, and the nozzle row groups between which the crosstalk occurs may be configured only with a pair of two adjacent nozzle rows for another reason. For example, two nozzle rows may be formed in one head chip, so that the pair of two adjacent nozzle rows constitute nozzle row groups between which the crosstalk occurs.

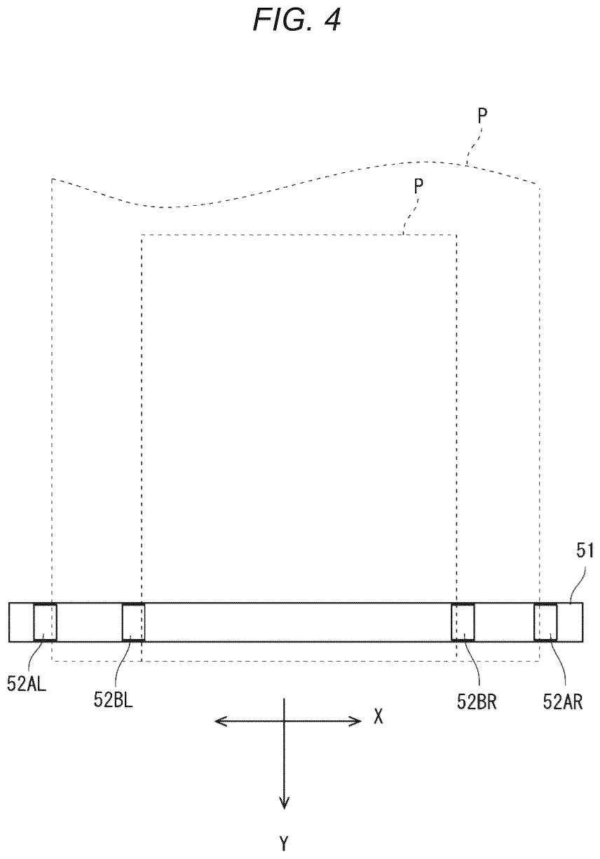

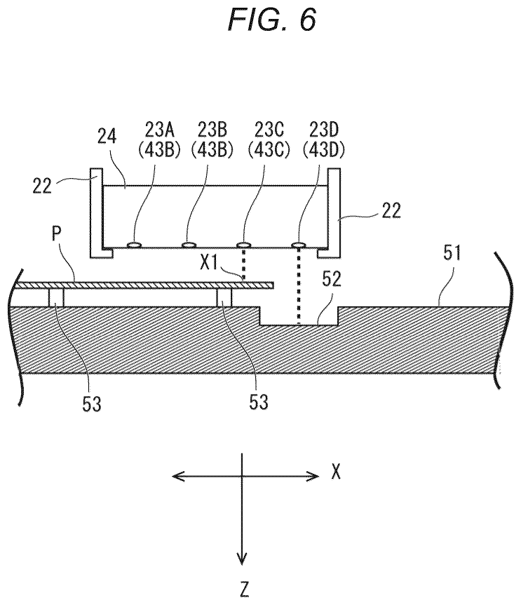

The platen 51 will next be described. FIG. 4 is a diagrammatic view showing an example of the configuration of the platen 51. In more detail, FIG. 4 is a diagrammatic view of a surface of the platen 51 that is the surface at which the medium P is placed. The platen 51 has liquid receiving regions 52AR, 52AL, 52BR, and 52BL, which receive the liquid (ink) ejected from the print head 24, as shown in FIG. 4. The liquid receiving regions 52AR, 52AL, 52BR, and 52BL will be hereinafter referred to as liquid receiving regions 52 when they are not particularly distinguished from each other. The liquid receiving regions 52 receive the ink ejected by the flushing operation, which will be described later, or receive the ink spilling off the width of the medium P in what is called borderless printing in which a printing region without a margin is set on the medium P for printing. The liquid receiving regions 52 may each be provided in the form of a groove, for example, to prevent the liquid ejected to the liquid receiving region 52 from adhering to the medium P, for example, when an end portion of the medium P hangs down toward the platen 51 due to the weight of the medium P itself. The liquid receiving regions 52 may each be provided with an absorber made of a material capable of absorbing the liquid, such as sponge or felt. Note that although not shown in FIG. 4, the medium P is supported by multiple ribs (see ribs 53 in FIG. 6) provided at the surface of the platen 51.

Multiple types of media P having different sizes to be handled by the printing apparatus 20 can be placed at the platen 51. In the example shown in FIG. 4, the printing apparatus 20 can perform printing on media P having two sizes by way of example. The liquid receiving regions 52 are disposed in correspondence with the position of the end, in the primary scanning direction, of the medium P to be used. Each of the liquid receiving regions 52 is disposed to contain at least a predetermined region outside the end of the medium P in the primary scanning direction, and may be disposed to further contain a region inside the end of the medium P, as shown in FIG. 4. The reason why the liquid receiving regions 52 are each disposed to include a region inside the end of the medium P is, for example, that the position of the medium P may have an error.

The liquid receiving regions 52 are provided for each of the sizes of the media P. In the example shown in FIG. 4, the liquid receiving region 52AR is the liquid receiving region 52 provided at one end of a medium P having a first size, and the liquid receiving region 52AL is the liquid receiving region 52 provided at the other end of the medium P having the first size. Similarly, the liquid receiving region 52BR is the liquid receiving region 52 provided at one end of a medium P having a second size, and the liquid receiving region 52BL is the liquid receiving region 52 provided at the other end of the medium P having the second size. As described above, when there are multiple sizes as the size of the medium P handled by the printing apparatus 20, there are multiple pairs of liquid receiving regions 52, but when there is only one size of the medium P handled by the printing apparatus 20, there may be one pair of liquid receiving regions 52. In the present embodiment, the liquid receiving regions 52 are provided on opposite sides of the medium P, but the liquid receiving region 52 may be provided only on one side of the medium P.

The controller 70 (see FIG. 1) includes a processor 71, a memory 72, and an interface (I/F) 73. The controller 70 thus has the function as a computer.

The memory 72 is configured, for example, with the combination of a volatile memory and a nonvolatile memory. The memory 72 is used to store a program executed by the processor 71 and data and the like used in various types of processing. The memory 72 may store the positions and sizes of the liquid receiving regions 52. The memory 72 further stores print data transmitted from a user's PC 10, which is a general-purpose personal computer, via the interface 73.

The processor 71 reads the program from the memory 72 and executes the program. The processor 71 thus implements various processes of controlling the printing apparatus 20. The processor 71 may, for example, be a microprocessor, a microprocessor unit (MPU), or a central processing unit (CPU). The processor 71 may include multiple processors.

The controller 70 outputs a drive signal directed to the print head 24, a drive signal directed to the drive motor 33, a drive signal directed to the carriage motor 34a, and other signals based on the processes carried out by the processor 71 to control the printing operation.

When the controller 70 receives, for example, print data that is dot data generated by the user's PC 10 and various print settings along with a print instruction, the controller 70 loads the print data into a print buffer region provided in the memory 72. Note that the print settings may include the size of the medium P. The controller 70 then controls the drive motor 33 to rotate the sheet feeding roller 35 to convey the medium P onto the platen 51. The controller 70 then causes the print head 24 to eject the liquid via the nozzles 23 while controlling the carriage motor 34a to move the carriage 22 in the primary scanning direction to form dots on the medium P. An image is thus formed on the medium P.

The flushing performed in the present embodiment will now be described. In the printing apparatus 20 according to the present embodiment, when the print head 24 (carriage 22) is moved toward one side in the primary scanning direction, the image formation on the medium P and the flushing through the nozzles 23 in the liquid receiving regions 52 are both performed. Hereinafter, the movement of the print head 24 (carriage 22) toward one side in the primary scanning direction is referred to as a pass, and one movement of the print head 24 (carriage 22) toward one side in the primary scanning direction is referred to as one pass (one pass operation).

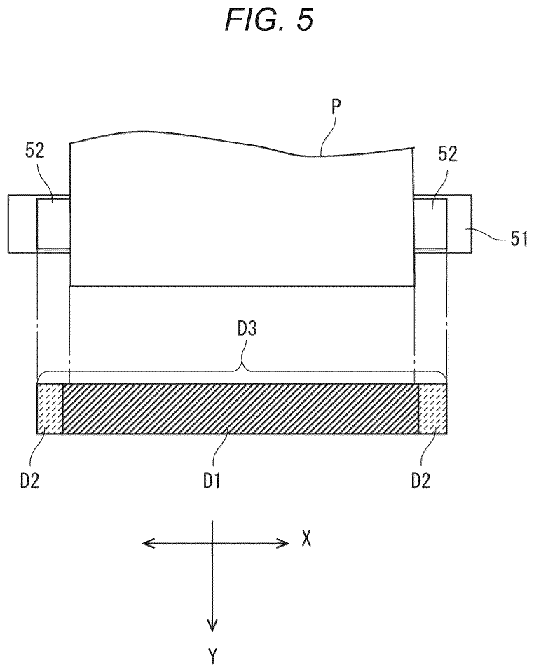

FIG. 5 is a diagrammatic view showing liquid ejection data used to perform the image formation and the flushing in one pass. The controller 70 generates flushing data D2, which is control data used to eject the liquid via the nozzles 23 into the liquid receiving regions 52 according to the size of the medium P, as shown in FIG. 5. The flushing data D2 is, for example, data that instructs the print head 24 to perform the flushing, in which large-dot ink droplets are ejected via all the nozzles 23 that constitute one nozzle row 43, and the flushing data D2 contains information indicating a flushing target nozzle row and used to control the timing when the flushing is performed. Note that the flushing target nozzle row refers to the nozzle row on which the flushing is performed. The controller 70 generates liquid ejection data D3 used to control the ejection of the liquid in one pass by adding the flushing data D2 to the print data D1 corresponding to the one pass. Note in the present embodiment that borderless printing can be performed, and to this end, the width, in the primary scanning direction, of the region where the liquid is ejected based on the print data D1 is greater than or equal to the width of the medium P, as shown in FIG. 5. Note, however, that the printing apparatus 20 may perform what is called bordered printing in which the medium P has a margin along the edge thereof. In this case, the width, in the primary scanning direction, of the region where the liquid is ejected based on the print data is smaller than the width of the medium P.

The controller 70 performs printing corresponding to one pass while moving the carriage 22 based on the liquid ejection data. Formation of an image on the medium P and the flushing through the nozzles 23 in the liquid receiving regions 52 are thus performed in the one pass. That is, the controller 70 performs printing ejection (first ejection) that is ejection of the liquid for the formation of an image on the medium P and flushing ejection (second ejection) that is ejection of the liquid for the flushing in the predetermined region outside the end of the medium P in the primary scanning direction, with the two types of ejection performed during one movement of the carriage 22 in the primary scanning direction. Performing the operation described above allows the image formation and the flushing to be efficiently performed. In particular, since the flushing is performed near the end of the medium P, the amount of movement of the carriage 22 can be suppressed as compared with a case where the flushing is performed at a position far away from the medium P. The throughput of the image formation can therefore be improved by performing the flushing near the end of the medium P.

Those having disclosed the present disclosure, however, have found a problem with the flushing described above that causes in some cases deterioration of the quality of an image printed on the medium P due to the crosstalk. FIG. 6 is a diagrammatic view showing flushing according to Comparative Example. FIG. 6 shows a state in which the flushing is performed in the liquid receiving region 52 at the right end of the medium P. Note that when printing is performed, the medium P is placed at the multiple ribs 53 provided at the surface of the platen 51, as shown in FIG. 6. The liquid receiving region 52 is provided below and outside the end of the medium P. Note that the position where the liquid receiving region 52 is disposed can also be described below. The liquid receiving region 52 is provided at a position where at least a portion of the carriage 22, in which the print head 24, which ejects the liquid used to perform the flushing toward the liquid receiving region 52, is incorporated, overlaps with the medium P when viewed in the direction in which the liquid is ejected (Z direction in FIG. 6) at the time when the flushing is performed. In the print head 24, when the nozzle row 43A (nozzle row 43B) is the flushing target nozzle row, the nozzle row 43B (nozzle row 43A) is the affected nozzle row, as described above. When the nozzle row 43C (nozzle row 43D) is the flushing target nozzle row, the nozzle row 43D (nozzle row 43C) is the affected nozzle row.

It is assumed that when the print head 24 is at the position shown in FIG. 6, the nozzle row 43D ejects the liquid for the flushing, that is, performs the flushing ejection described above. It is further assumed that the nozzle rows 43A to 43C eject at this point in time the liquid for printing an image based on the print data on the medium P, that is, perform the printing ejection described above. Note in FIG. 6 that it may be understood that the carriage 22 is moving rightward or leftward. When the nozzle row 43D performs the flushing, the ejection of the liquid via the nozzle row 43C is affected by the crosstalk, as described above. The shape of the liquid droplets ejected via the nozzle row 43C and landed at a position X1 in the primary scanning direction therefore undesirably changes from an ideal shape. As a result, a streak extending in the direction (conveyance direction) perpendicular to the primary scanning direction appears on the medium P at the position X1 in the primary scanning direction, which the position where the droplets ejected via the nozzle row 43C are landed. The quality of the image printed on the medium P therefore deteriorates. Note in FIG. 6 that the flushing performed at the right end of the medium P has been described by way of example, and the image quality may deteriorate in the same manner when the flushing is performed on the left side of the medium P.

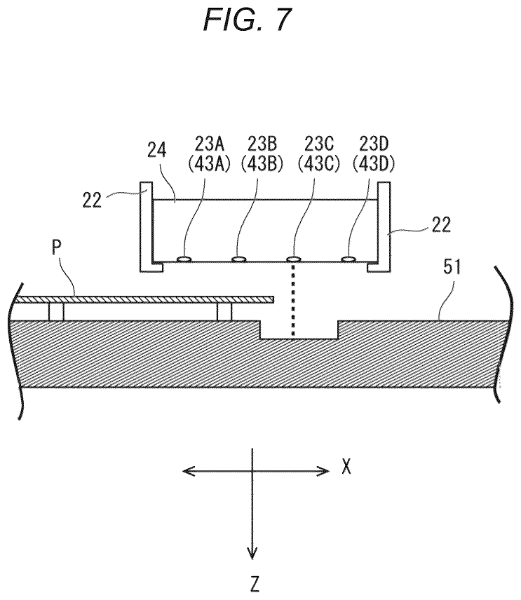

To avoid the deterioration described above, the controller 70 performs the flushing in the present embodiment at a timing when the image quality of an image printed on the medium P does not deteriorate even when the crosstalk occurs. FIG. 7 is a diagrammatic view showing the flushing according to the embodiment. FIG. 7 also shows the state in which the flushing is performed in the liquid receiving region 52 at the right end of the medium P, as in FIG. 6. The controller 70 performs the flushing through the flushing target nozzle row (nozzle row 43C in FIG. 7) at a timing when the affected nozzle row (nozzle row 43D in FIG. 7), which is affected by the liquid ejected by the flushing performed on the flushing target nozzle row, is located outside the medium P, as shown in FIG. 7. In detail, the controller 70 performs the flushing at a timing when the affected nozzle row (nozzle row 43D in FIG. 7) is located outside the medium P and at least a portion of the carriage 22 is present at a position where the portion overlaps with the medium P when viewed in the direction in which the liquid is ejected. Performing the flushing as described above can suppress deterioration of the image quality due to the crosstalk accompanying the flushing. In more detail, note that the controller 70 performs the flushing not only at the timing described above but also at the timing when the flushing target nozzle row is present directly above the liquid receiving region 52.

Not only the position of the affected nozzle row being outside the medium P but also the position of the affected nozzle row being outside an image formation range may be used as the condition of the timing when the flushing is performed. The image formation range used herein is the range in the primary scanning direction where the printing ejection (first ejection), which is the ejection of the liquid for forming an image on the medium P, is performed. In the borderless printing, the width of the image formation range is greater than the width of the medium P. At a timing when the position of the affected nozzle row is not only outside the medium P but also outside the image formation range, the position of the affected nozzle row during the period for which the flushing is performed can be further separate from the medium P. Deterioration of the quality of the image formed on the medium P can therefore be more reliably avoided. As described above, the controller 70 may perform the flushing at a timing when the affected nozzle row is located outside the image formation range and the medium P and at least a portion of the carriage 22 is present at a position where the portion overlaps with the medium P when viewed in the direction in which the liquid is ejected.

Note in the present embodiment that the controller 70 sequentially selects any one of the multiple nozzle rows 43 of the print head 24 as the flushing target nozzle row. For example, in FIG. 7, when the carriage 22 is moving rightward, the controller 70 selects the nozzle row 43C and the nozzle row 43A in this order as the flushing target nozzle. In FIG. 7, when the carriage 22 is moving leftward, the controller 70 selects the nozzle row 43A and the nozzle row 43C in this order as the flushing target nozzle. That is, in the flushing at a first end of the medium P (right end of medium P shown in FIG. 7), the nozzle rows (nozzle rows 43A and 43C) present at a second end of the medium P (left end of medium P) out of the pairs of nozzle rows between which the crosstalk occurs are sequentially selected in the direction opposite the moving direction of the carriage 22. Note that the flushing may be performed only when the carriage 22 is moving rightward, may be performed only when the carriage 22 is moving leftward, or may be performed both when the carriage 22 is moving rightward and when the carriage 22 is moving leftward.

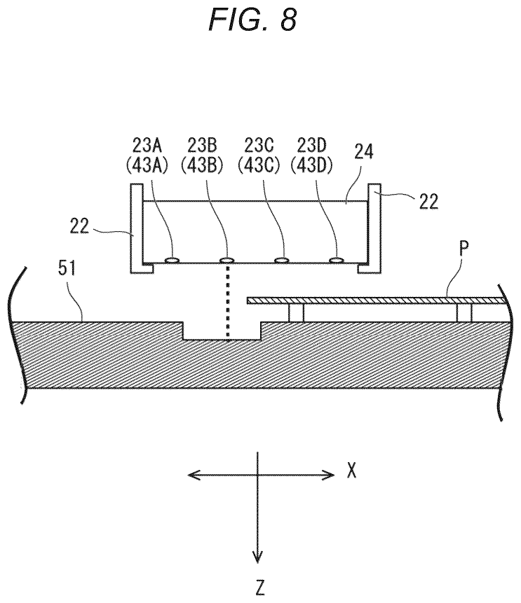

The flushing operation performed in the liquid receiving region 52 at the right end of the medium P has been described, and the same applies to a case where the flushing is performed in the liquid receiving region 52 at the left end of the medium P. FIG. 8 is a diagrammatic view showing the flushing performed in the liquid receiving region 52 at the left end of the medium P. The controller 70 performs the flushing through the flushing target nozzle row (nozzle row 43B in FIG. 8) at a timing when the affected nozzle row (nozzle row 43A in FIG. 8) is located outside the medium P and at least a portion of the carriage 22 is present at a position where the portion overlaps with the medium P when viewed in the direction in which the liquid is ejected, as shown in FIG. 8. Note in FIG. 8 that when the carriage 22 is moving rightward, the controller 70 selects the nozzle row 43D and the nozzle row 43B in this order as the flushing target nozzle. In FIG. 8, when the carriage 22 is moving leftward, the controller 70 selects the nozzle row 43B and the nozzle row 43D in this order as the flushing target nozzle. That is, in the flushing at the second end of the medium P (left end of medium P shown in FIG. 8), the nozzle rows (nozzle rows 43B and 43D) present at the first end of the medium P (right end of medium P) out of the pairs of nozzle rows between which the crosstalk occurs are sequentially selected in the direction opposite the moving direction of the carriage 22. Note that even in the flushing at the left end of the medium P, the flushing may be performed only when the carriage 22 is moving rightward, may be performed only when the carriage 22 is moving leftward, or may be performed both when the carriage 22 is moving rightward and when the carriage 22 is moving leftward.

As described above, in the present embodiment, the liquid is ejected to perform the flushing in a first region (liquid receiving region 52 at right end of medium P) outside the first end (right end) of the medium P in the primary scanning direction and a second region (liquid receiving region 52 at left end of medium P) outside the second end (left end) of the medium P in the primary scanning direction. In the flushing in the first region (liquid receiving region 52 at right end of medium P), the flushing is performed on one (nozzle rows 43A and 43C) of each of the pairs of nozzle rows between which the crosstalk occurs as the flushing target nozzle row. In the flushing in the second region (liquid receiving region 52 at left end of medium P), the flushing is performed on the other (nozzle rows 43B and 43D) of each of the pairs of nozzle rows between which the crosstalk occurs as the flushing target nozzle row. The flushing can thus be performed on all the nozzle rows.

In the present embodiment, out of the pairs of nozzle rows between which the crosstalk occurs, the flushing is performed only on the nozzle row close to an end of the medium P as the flushing target nozzle row at the timing described above when the flushing is performed, as shown in FIGS. 7 and 8. That is, in the example shown in FIG. 7, out of the nozzle rows 43C and 43D, which form a pair of nozzle rows between which the crosstalk occurs, the flushing is performed only on the nozzle row 43C, which is closer to an end of the medium P, as the flushing target nozzle row. Similarly, in the example shown in FIG. 8, out of the nozzle rows 43A and 43B, which are a pair of nozzle rows between which the crosstalk occurs, the flushing is performed only on the nozzle row 43B, which is closer to an end of the medium P, as the flushing target nozzle row. The width of the liquid receiving region 52 provided at an end of the medium P in the primary scanning direction can thus be reduced, so that the platen 51 is designed with an improved degree of freedom.

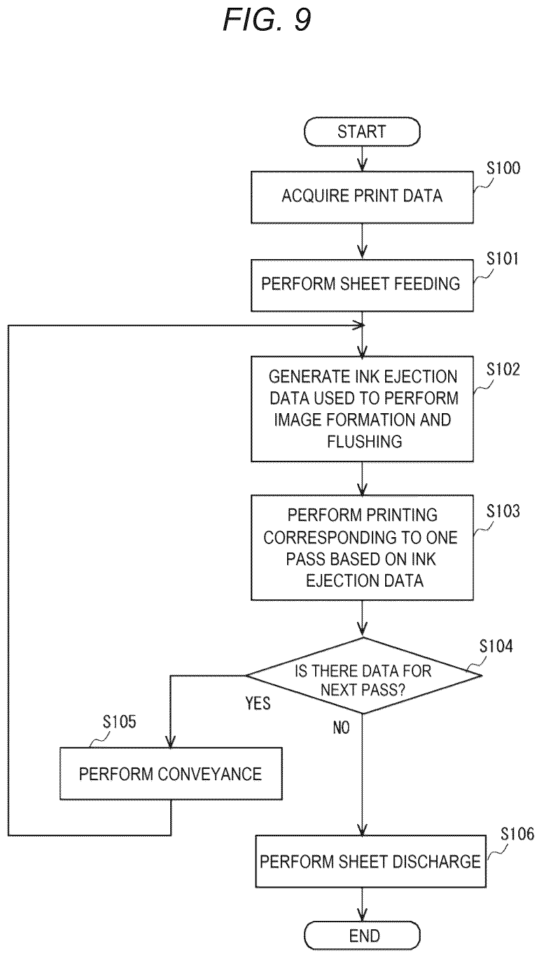

The operation of the printing apparatus 20 will next be described with reference to a flowchart. FIG. 9 is a flowchart showing an example of the procedure of the operation of the printing apparatus 20.

In step S100, the controller 70 acquires print data used to print an image on the medium P. In the present embodiment, the controller 70 acquires print data used, for example, to perform borderless printing on the medium P.

Next, in step S101, the controller 70 performs sheet feeding. That is, the controller 70 controls the drive motor 33 in a way that the medium P is fed onto the platen 51.

Next, in step S102, the controller 70 generates the flushing data described above, and generates the liquid ejection data used to control the ejection of the liquid in one pass based on the print data and the generated flushing data. That is, the controller 70 generates the liquid ejection data used to perform the image formation on the medium P and the flushing in the one pass.

Next, in step S103, the controller 70 performs printing corresponding to the one pass while moving the carriage 22 based on the generated liquid ejection data. Therefore, an image is printed on the medium P, and the flushing at an end of the medium P is performed. In this process, the controller 70 performs the flushing on the flushing target nozzle at the timing described above.

Next, in step S104, the controller 70 determines whether there is print data to be printed in the next pass. When there is print data for the next pass, the controller 70 conveys, in step S105, the medium P by a predetermined amount for printing in the next pass, and the controller 70 returns to the process in step S102. On the other hand, when it is determined in step S104 that there is no data to be printed in the next pass, the controller 70 controls, in step S106, the drive motor 33 in a way that the medium P is discharged from the platen 51, and terminates the procedure.

The embodiment has been described above. In the printing apparatus 20, the flushing is performed at a timing when the affected nozzle row is located outside the medium P and at least a portion of the carriage 22 is present at a position where the portion covers the medium P, as described above. Performing the flushing at the timing described above can suppress deterioration of the image quality of an image formed on the medium P due to the crosstalk accompanying the flushing. In the configuration of the print head 24 according to the present embodiment, the affected nozzle row is a nozzle row disposed adjacent to the flushing target nozzle row. Even when the printing apparatus 20 is thus configured, the deterioration of the image quality due to the crosstalk accompanying the flushing can be suppressed because the flushing is performed at the timing described above. Therefore, for example, even in the print head shown in FIG. 3, a print head in which two nozzle rows are formed in one head chip, or a print head having a similar configuration, deterioration of the image quality due to the crosstalk accompanying the flushing can be suppressed. The print head can therefore be designed with an improved degree of freedom. When the borderless printing is performed, that is, when the image formation range is greater than or equal to the width of the medium P in the primary scanning direction, the printing apparatus 20 performs the flushing at the timing described above. In the borderless printing, printing for image formation is performed at a position close to the liquid receiving region 52 where the flushing is performed. The borderless printing is therefore likely to cause the deterioration of the image quality due to the crosstalk. In the present embodiment, however, the flushing is performed at the timing described above, so that the deterioration of the image quality can be suppressed even when such printing is performed.

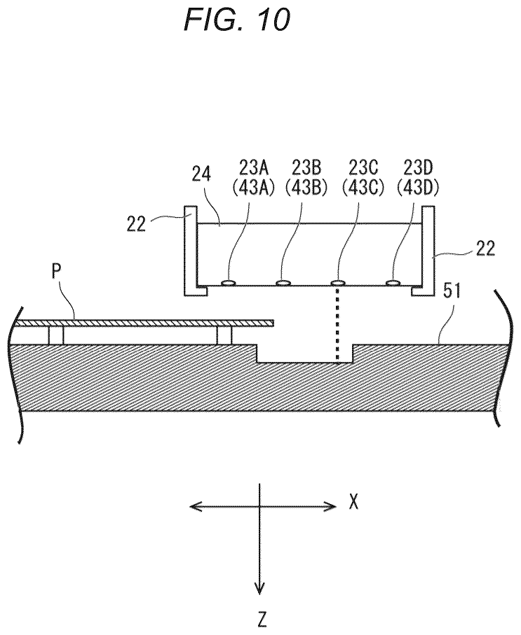

Note that the present disclosure is not limited to the embodiment described above and can be changed as appropriate to the extent that the change does not depart from the intent of the present disclosure. For example, in the embodiment described above, the affected nozzle row is only one nozzle row present on one side of the flushing target nozzle row, and two nozzle rows present on opposite sides of the flushing target nozzle row may each be the affected nozzle row. Also in this case, the flushing for the flushing target nozzle rows may be performed at a timing when the affected nozzle rows are each located outside the medium P, as shown in FIG. 10. The flushing described above will be described with reference to FIG. 10. Note that the same items as those described in the embodiment will not be described as appropriate. FIG. 10 is a diagrammatic view showing the flushing performed when two nozzle rows present on opposite sides of the flushing target nozzle row are each the affected nozzle row. FIG. 10 shows a state in which the flushing is performed in the liquid receiving region 52 at the right end of the medium P by way of example. The controller 70 performs the flushing through the flushing target nozzle row at a timing when the affected nozzle rows (nozzle rows 43B and 43D in FIG. 10) affected by the ejection of the liquid when the flushing is performed on the flushing target nozzle row (nozzle row 43C in FIG. 10) is located outside the medium P, as shown in FIG. 10. In more detail, the controller 70 performs the flushing at a timing when the affected nozzle rows (nozzle rows 43B and 43D in FIG. 10) are located outside the medium P and at least a portion of the carriage 22 is present at a position where the portion overlaps with the medium P when viewed in the direction in which the liquid is ejected. Performing the flushing as described above can suppress deterioration of the image quality due to the crosstalk accompanying the flushing even when the nozzle rows on opposite sides of the flushing target nozzle row are each the affected nozzle row.

Note that even when the nozzle rows on opposite sides of the flushing target nozzle row are each the affected nozzle row, the controller 70 may sequentially select each of the multiple nozzle rows 43 of the print head 24 as the flushing target nozzle row. For example, in FIG. 10, when the carriage 22 is moving rightward, the controller 70 may select the nozzle rows 43D, 43C, 43B, and 43A in this order as the flushing target nozzle. In FIG. 10, when the carriage 22 is moving leftward, the controller 70 may select the nozzle rows 43A, 43B, 43C, and 43D in this order as the flushing target nozzle. That is, in the flushing at the first end of the medium P (right end of medium P shown in FIG. 10), the nozzle rows 43 incorporated in the print head 24 may be sequentially selected in the direction opposite the moving direction of the carriage 22. Note that the flushing may be performed only when the carriage 22 is moving rightward, may be performed only when the carriage 22 is moving leftward, or may be performed both when the carriage 22 is moving rightward and when the carriage 22 is moving leftward. The flushing operation performed in the liquid receiving region 52 at the right end of the medium P has been described above, and the same applies to the case where the flushing is performed in the liquid receiving region 52 at the left end of the medium P. When the nozzle rows on opposite sides of the flushing target nozzle row are the affected nozzle rows, not only the positions of the affected nozzle rows being outside the medium P but also the position of the affected nozzle row being outside an image formation range may be used as the condition of the timing when the flushing is performed.

In the present disclosure, the program includes an instruction group (or software codes) that causes a computer to perform one or more of the functions described in the embodiment when the program is read into the computer. The program may be stored in a non-transitory computer-readable medium or a tangible storage medium. Examples of the computer-readable medium or the tangible storage medium include, but not limited to, a random-access memory (RAM), a read-only memory (ROM), a flash memory, a solid-state drive (SSD) or devices based on other memory technologies, a CD-ROM, a digital versatile disk (DVD), a Blu-ray (trademark registered) disc or other optical disc storages, a magnetic cassette, a magnetic tape, a magnetic disk storage or other magnetic storage devices. The program may be transmitted via a transitory computer-readable medium or a communication medium. Examples of the transitory computer-readable medium or the communication medium include, but not limited to, a propagation signal of an electric, optical, acoustic, or another form.

A part or the entire embodiment and the variations described above can also be described in, but not limited to, the additional remarks below.

### Additional Remark 1

A printing method performed by a printing apparatus including a print head having multiple nozzle rows, a carriage in which the print head is incorporated, and a controller configured to control ejection of liquid via the nozzle rows and movement of the carriage in a primary scanning direction, the printing method including
performing, during a one-pass operation of moving the carriage, first ejection that is ejection of the liquid for forming an image on a medium, and second ejection that is ejection of the liquid for flushing in a predetermined region outside an end of the medium in the primary scanning direction,
wherein the second ejection through a flushing target nozzle row that is the nozzle row on which the second ejection is performed is performed at a timing when an affected nozzle row is located outside the medium and at least a portion of the carriage is present at a position where the portion overlaps with the medium when viewed in a direction in which the liquid is ejected,
the one-pass operation is an operation of moving the carriage once toward one side in the primary scanning direction, and
the affected nozzle row is the nozzle row affected by the ejection of the liquid due to the second ejection performed through the flushing target nozzle row.

### Additional Remark 2

The printing method according to Additional Remark 1, wherein
the second ejection is performed on the flushing target nozzle row when the affected nozzle row is located outside an image formation range that is a range which extends in the primary scanning direction and in which the first ejection is performed.

### Additional Remark 3

The printing method according to Additional Remark 1 or 2, wherein
the affected nozzle row is the nozzle row disposed adjacent to the flushing target nozzle row.

### Additional Remark 4

The printing method according to any one of Additional Remarks 1 to 3, wherein
the multiple nozzle rows include a first nozzle row and a second nozzle row arranged in the primary scanning direction,
the second nozzle row is the affected nozzle row when the first nozzle row is the flushing target nozzle row,
the first nozzle row is the affected nozzle row when the second nozzle row is the flushing target nozzle row, and
the second ejection is performed at the timing with only one of the first and second nozzle rows that is closer to the end of the medium selected as the flushing target nozzle row.

### Additional Remark 5

The printing method according to Additional Remark 4, wherein
the second ejection is performed in a first region outside a first end of the medium in the primary scanning direction and a second region outside a second end of the medium in the primary scanning direction,
in the second ejection in the first region, the second ejection is performed with the second nozzle row selected as the flushing target nozzle row, and
in the second ejection in the second region, the second ejection is performed with the first nozzle row selected as the flushing target nozzle row.

### Additional Remark 6

The printing method according to any one of Additional Remarks 1 to 5, wherein
when an image formation range that is a range which extends in the primary scanning direction and in which the first ejection is performed is greater than or equal to a width of the medium in the primary scanning direction, the second ejection through the flushing target nozzle row is performed at the timing.

### Additional Remark 7

A printing apparatus including:
a print head having multiple nozzle rows;
a carriage in which the print head is incorporated; and
a controller configured to control ejection of liquid via the nozzle rows and movement of the carriage in a primary scanning direction,
wherein the controller is configured to perform, during a one-pass operation of moving the carriage, first ejection that is ejection of the liquid for forming an image on a medium, and second ejection that is ejection of the liquid for flushing in a predetermined region outside an end of the medium in the primary scanning direction,
the second ejection through a flushing target nozzle row that is the nozzle row on which the second ejection is performed is performed at a timing when an affected nozzle row is located outside the medium and at least a portion of the carriage is present at a position where the portion overlaps with the medium when viewed in a direction in which the liquid is ejected,
the one-pass operation is an operation of moving the carriage once toward one side in the primary scanning direction, and
the affected nozzle row is the nozzle row affected by the ejection of the liquid due to the second ejection through the flushing target nozzle row.

What is claimed is:

1. A printing method performed by a printing apparatus including a print head having multiple nozzle rows, a carriage in which the print head is incorporated, and a controller configured to control ejection of liquid via the nozzle rows and movement of the carriage in a primary scanning direction, the printing method comprising
performing, during a one-pass operation of moving the carriage, first ejection that is ejection of the liquid for forming an image on a medium, and second ejection that is ejection of the liquid for flushing in a predetermined region outside an end of the medium in the primary scanning direction,
wherein the second ejection through a flushing target nozzle row that is the nozzle row on which the second ejection is performed is performed at a timing when an affected nozzle row is located outside the medium and at least a portion of the carriage is present at a position where the portion overlaps with the medium when viewed in a direction in which the liquid is ejected,
the one-pass operation is an operation of moving the carriage once toward one side in the primary scanning direction, and
the affected nozzle row is the nozzle row affected by the ejection of the liquid due to the second ejection performed through the flushing target nozzle row.

2. The printing method according to claim 1, wherein
the second ejection is performed on the flushing target nozzle row when the affected nozzle row is located outside an image formation range that is a range which extends in the primary scanning direction and in which the first ejection is performed.

3. The printing method according to claim 1, wherein
the affected nozzle row is the nozzle row disposed adjacent to the flushing target nozzle row.

4. The printing method according to claim 1, wherein
the multiple nozzle rows include a first nozzle row and a second nozzle row arranged in the primary scanning direction,
the second nozzle row is the affected nozzle row when the first nozzle row is the flushing target nozzle row,
the first nozzle row is the affected nozzle row when the second nozzle row is the flushing target nozzle row, and
the second ejection is performed at the timing with only one of the first and second nozzle rows that is closer to the end of the medium selected as the flushing target nozzle row.

5. The printing method according to claim 4, wherein
the second ejection is performed in a first region outside a first end of the medium in the primary scanning direction and a second region outside a second end of the medium in the primary scanning direction,
in the second ejection in the first region, the second ejection is performed with the second nozzle row selected as the flushing target nozzle row, and
in the second ejection in the second region, the second ejection is performed with the first nozzle row selected as the flushing target nozzle row.

6. The printing method according to claim 1, wherein
when an image formation range that is a range which extends in the primary scanning direction and in which the first ejection is performed is greater than or equal to a width of the medium in the primary scanning direction, the second ejection through the flushing target nozzle row is performed at the timing.

7. A printing apparatus comprising:
a print head having multiple nozzle rows;
a carriage in which the print head is incorporated; and
a controller configured to control ejection of liquid via the nozzle rows and movement of the carriage in a primary scanning direction,
wherein the controller is configured to perform, during a one-pass operation of moving the carriage, first ejection that is ejection of the liquid for forming an image on a medium, and second ejection that is ejection of the liquid for flushing in a predetermined region outside an end of the medium in the primary scanning direction,
the second ejection through a flushing target nozzle row that is the nozzle row on which the second ejection is performed is performed at a timing when an affected nozzle row is located outside the medium and at least a portion of the carriage is present at a position where the portion overlaps with the medium when viewed in a direction in which the liquid is ejected,
the one-pass operation is an operation of moving the carriage once toward one side in the primary scanning direction, and
the affected nozzle row is the nozzle row affected by the ejection of the liquid due to the second ejection performed through the flushing target nozzle row.
